(19) United States
(12) Patent Application Publication
(10) Pub. No.: US 2002/0062551 A1
(43) Pub. Date: May 30, 2002

(54) Corner bead attachment device

(76) Inventor: Brian L. Jacoby, Carmel, IN (US)

Correspondence Address: Michael D. Beck, Maginot Moore & Bowman LLP, Bank One Center/Tower, 111 Monument Circle Suite 3000, Indianapolis, IN, 46204-5115, US

(21) Appl. No.: 09/727,045

(22) Filed: Nov. 30, 2000

(51) Int. Cl. B23P 19/00

(52) U.S. Cl. 29/798

(57) ABSTRACT

A device for securing a corner bead to a first and a second wall which define a corner in a room of a structure. The device includes a powered impact tool having an operative end with a crimping unit adapted to be secured to the operative end. The crimping unit includes a housing in which a claw assembly is disposed. The claw assembly includes at least a pair of arms each having a claw edge for piercing the corner bead. The claws are positioned opposite one another in the housing. The arms have a first, inoperative position and a second operative position such that when the impact tool is actuated, the arms move between the first position and the second position, so the claw edges contemporaneously pierce the corner bead and the first and second walls.

### BACKGROUND OF THE INVENTION

The present invention relates to a device used to secure a corner bead to a corner defined between two walls.

In building construction, walls of a structure are usually defined by sheets of dry wall. The dry wall sheets are aligned with one edge of a first sheet adjacent an edge of a second sheet. At the joints or corners between adjacent dry wall sheets there may exist a gap which must be covered. Where the gap is within the span of a wall, dry wall tape is effective to cover the gap.

However, where the gap is at a corner joint, drywall tape is inadequate. Moreover, the tape is not sufficiently strong to withstand the normal wear and tear experienced at a wall corner. To address both problems, the edges of the angles sheets of dry wall are covered and protected by a corner bead. A corner bead is a thin L-shaped metal sheet. Each leg of the L-shaped bead lies in flush contact with a corresponding dry wall sheet. Typically, a plurality of holes are disposed in each leg of the corner bead for receiving fasteners, such as nails or screws, which secure the corner bead to both walls. The corner bead defines uniform corners in the structure while protecting the edges of the dry wall.

In place of fasteners such as nails or screws, a device for crimping the edges of each leg of a corner bead inwardly into the drywall has been used. Such a device is provided with a pair of linkage arms having a sharp edge at one end thereof for bending the edges of the corner bead into the drywall, as depicted in U.S. Pat. No. 4,593,443 (Wolford). At the opposite end of the pivotably attached linkage arms is a spring loaded striker. In use, the crimping device is positioned against the corner bead when the bead is held against the wall. The device is actuated by an impact blow manually delivered by a rubber mallet, for example. When the device is actuated, the linkage arms pivot causing rotational movement of the sharp ends of the linkage arms into the pieces of dry wall. The edge of each leg of the corner bead is bent inwardly into the dry wall, thereby securing the corner bead in place.

One problem with the above described device is that it is manually operated. The use of this device is labor intensive wherein the operator must position the device on the corner bead and physically hit the striker, providing the impact blow to drive the sharp edges of the linkage arms into the dry wall. Further, the user must then reposition the device along the corner bead several times, striking the device at each of a plurality of locations along the corner bead until the bead is secured to the wall.

A further problem with this device is that if the ends of the corner bead are not sufficiently bent inward by the sharp edges of the linkage arms, the corner bead will not be adequately fastened to the dry wall and may therefore pull away from the corner over time. A further disadvantage of a crimping tool such as the one discussed above is the difficulty of having one person simultaneously handling the corner bead, the tool, and the mallot, while still aligning the corner bead properly along the two walls. The task of using such a crimping tool is time consuming and not particularly safe when trying to manage a plurality of components while working atop a ladder or scaffold, for example.

It is desired to provide a corner bead attachment device which is simple to use, while reducing the number of components necessary to attach the corner bead to the wall, thereby enabling a safer work environment.

### SUMMARY OF THE INVENTION

The present invention provides a device for securing a corner bead to a first and second wall, each of which has a free edge that are juxtaposed at a right angle to define a corner. The device includes a powered impact tool such as a nail gun and a crimping unit which is adapted to be removeably secured to the operative end of the impact tool. When the impact tool is actuated, the crimping unit advances a claw assembly disposed within the crimping unit toward the corner bead when the bead is against the walls.

The claw assembly includes a pair of crimping arms which are pivotably linked to move between a first inoperative position and a second operative position. The free end of each arm is provided with a sharp edge which pierces a portion of the corner bead, and compacts the dry wall to fasten the corner bead to the wall. In one aspect of the invention, the crimping arms are positioned to penetrate the interior of each leg of the corner bead, rather than simply at the edge.

The present invention, in one form thereof, provides a device for securing a corner bead to a first and a second wall. The device includes a powered impact tool having an operative end, and a crimping unit adapted to be secured to the operative end. The crimping unit includes a housing. A claw assembly is disposed in the housing and includes at least a pair of arms each having a claw edge for piercing the corner bead positioned opposite one another in the housing. The arms have a first, inoperative position and a second operative position, such that when the impact tool is actuated, the arms move between the first inoperative position and the second operative position, so the claw edges contemporaneously pierce the corner bead and the first and second walls.

In another aspect of the invention, a device for attaching a corner bead includes at least two claw arms each having a first end, a second end and a pivot point therebetween. The first end of each of the claw arms defines a sharp edge configured for piercing the interior of a leg of the corner bead. A crimping unit is provided to support the claw arms which has a pair of surfaces oriented relative to each other at the angle of the walls. The surfaces are configured to be pressed flush against the walls of the corner bead.

Each of the surfaces defines a slot for receiving the claw for movement therethrough. The slot is arranged on the corresponding surface to intersect the interior surface of a corresponding leg of the corner bead away from or inboard of the free edge of the bead leg. The crimping unit further includes a pivot support for pivotably supporting each of the pair of claw arms at the pivot point. The pivot support is arranged relative to the pair of surfaces so that each of the claw arms can pivot to extend the claw through a corresponding slot in the pair of surfaces.

A mechanism is connected to the second end of the claw arms for pivoting the claw arms relative to each other about the pivot support, whereby pivoting the claw arms forces the claw of each of the claw arms to pass through the slot in a corresponding surface of the crimping unit and to pierce the interior portion of each wall of the corner bead inboard of the free edge of the wall, each of the claws forms a notch in the interior portion to secure the corner bead to a corner of the structure.

One advantage of the corner bead attachment device is that it can be mechanically powered and operated, thereby eliminating the use of a hammer or mallot to actuate a manually operated device. A further advantage of the present invention is that the unit may be easily moved along the corner bead to allow the user to quickly and safely attach the corner bead to the wall, preventing the corner bead from pulling away from the wall.

Yet another advantage is that the claws of the device are offset which provides additional stability to the crimped corner bead. Other advantages and objects of the invention can be discerned from the following written description of the invention and the accompanying figures.

### DESCRIPTION OF THE FIGURES

The above-mentioned and other features and advantages of this invention, and the manner of attaining them, will become more apparent and the invention itself will be better understood by reference to the following description of an embodiment of the invention taken in conjunction with the accompanying drawings, wherein:

FIG. 1 is a rear perspective view showing a corner bead attachment device according to one embodiment of the invention positioned along a corner defined by a pair of walls;

FIG. 2 is a front perspective view of the corner bead attachment device shown in FIG. 1;

FIG. 3 is an exploded perspective view of the corner bead attachment device of FIG. 2;

FIG. 4 is a side elevational view of a crimping unit in accordance with one embodiment of the present invention forming part of the corner bead attachment device of FIGS. 1-3;

FIG. 5 is a bottom elevational view of the crimping unit of FIG. 4;

FIG. 6 is a side elevational view of the claw assembly used with the crimping unit of FIG. 4 shown in a first, inoperative position;

FIG. 7 is a side elevational view of the claw assembly of FIG. 6 shown in a second, operative position;

FIG. 8 is a bottom elevational view of the claw assembly of FIG. 7 taken along line 8-8 as viewed in the direction of the arrows;

FIG. 9 is a side elevational view of the claw assembly of FIG. 7 taken along line 9-9 as viewed in the direction of the arrows;

FIG. 10 is a side partial sectional view of the crimping unit shown in FIG. 4 with the claw assembly in a first, inoperative position; and

FIG. 11 is a side partial sectional view of the crimping unit shown in FIG. 4 with the claw assembly in a second, operative position.

Corresponding reference characters indicate corresponding parts throughout the several views. The exemplification set out herein illustrates one preferred embodiment of the invention, in one form, and such exemplification is not to be construed as limiting the scope of the invention in any manner.

### DESCRIPTION OF THE PREFERRED EMBODIMENT

For the purposes of promoting an understanding of the principles of the invention, reference will now be made to the embodiments illustrated in the drawings and specific language will be used to describe the same. It will nevertheless be understood that no limitation of the scope of the invention is thereby intended. The inventions includes any alterations and further modifications in the illustrated devices and described methods and further applications of the principles of the invention which would normally occur to one skilled in the art to which the invention relates.

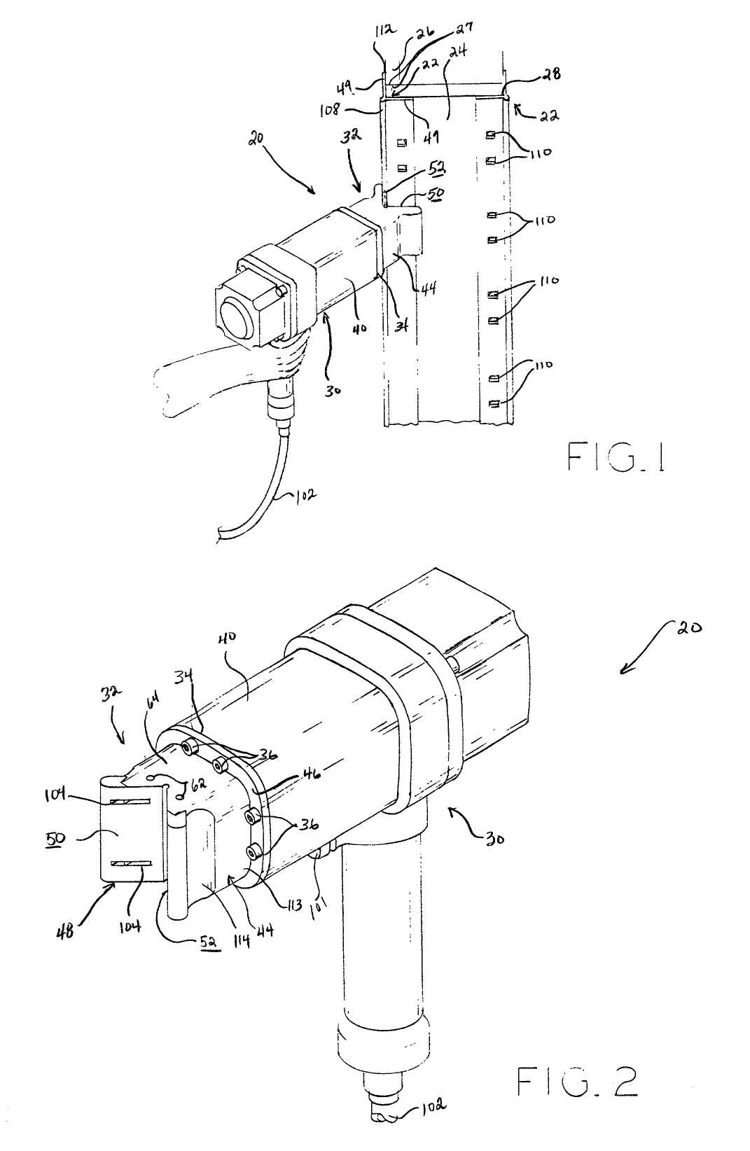

Referring to FIG. 1, corner bead attachment device 20 is used for simultaneously securing corner bead 22 to first wall 24 and second wall 26 which have free edges 27 in at least partially abutting relationship to define corner 28 (FIGS. 10 and 11). In general, walls 24 and 26 are defined by sheets of dry wall which are oriented such that free edges 27 overlap to define corners 28 in a room of a structure. In order to protect the corners from damage, corner bead 22 is secured to both walls 24 and 26. The typical corner bead is formed from thin gage sheet metal, such as stainless steel. Once secured, dry wall mud is smoothed over corner bead 22 to hide bead 22 from view and further protect corner 28. Device 20 as shown in FIGS. 1 and 2 is used to crimp portions of corner bead 22 into walls 24 and 26, thereby securing corner bead 22 to the walls.

Referring to FIGS. 1-3, in a preferred aspect of the invention device 20 includes a powered impact tool 30. Device 20 further includes crimping unit 32 which is removably fastened to the operative end 34 of impact tool 30 by threaded fasteners 36 such as screws or bolts. The impact tool 30 can be of a known design, such as a pneumatic nail gun. The working end of the nail gun can be removed so the crimping unit 32 can be mated to the gun and its working components. When the original working end of tool 30 is removed, apertures 38 remain in barrel portion 40 of tool 30. Fasteners 36 extend through apertures 42 in flange 46 of crimping unit 32, threadingly engaging apertures 38 in barrel portion 40 to secure crimping unit 32 onto tool 30.

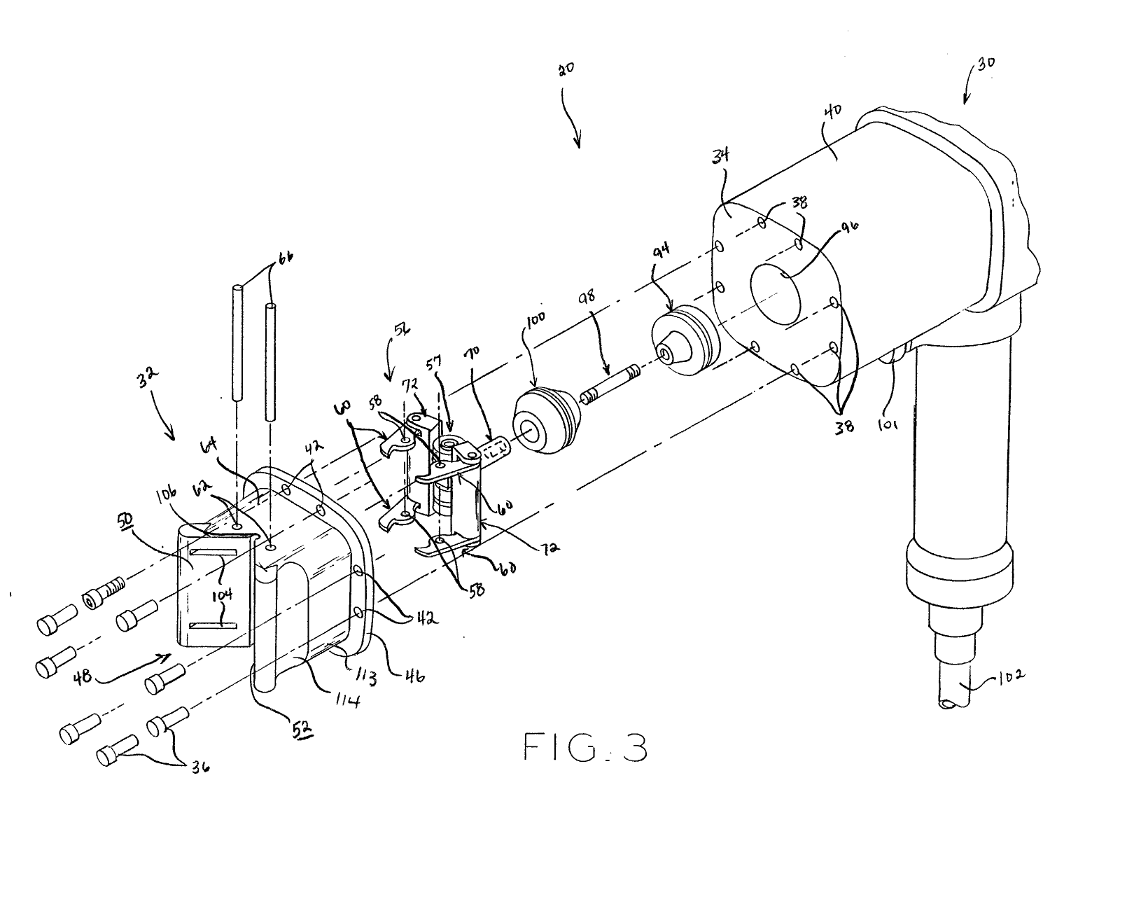

Referring to FIGS. 3, 4, and 5, crimping unit 32 includes housing 44 having flange 46 extending approximately perpendicularly from the outer surface of housing 44. Housing 44 is preferably constructed from a hard plastic material, such as PVC, by any suitable method such as injection molding. The opposite end or operative end 48 of housing 44 defines two surfaces 50 and 52 which are disposed at a 90° angle to one another. The angle between surfaces 50, 52 corresponds to the angle of corner bead 22 to allow flush abutment of crimping unit 32 to corner bead 22. In addition, the surfaces 50, 52 help push corner bead 22 flush against walls 24 and 26. For example, if walls 24 and 26 are also disposed at a right angle or 90° angle to each other, legs 49 of corner bead 22 and thus surfaces 50, 52 of the housing 44 are disposed at a 90° angle. The angle between surfaces 50, 52 as well as the angle of corner bead 22 may be at any angle equivalent to that of walls 24 and 26. If, for example, walls 24 and 26 are disposed at a 45° angle relative to one another, legs 49 of corner bead 22 and surfaces 50, 52 of housing 44 will also be at a 450 angle relative to one another to allow the abutment of bead 22 and surfaces 50, 52 against the corner. In order to accomplish this, different crimping units 32 may be produced having different angles between surfaces 50, 52, although, a right angle between the surfaces is most common.

Referring to FIGS. 10 and 11, housing 44 of crimping unit 32 is hollow to define chamber 54 for receiving claw assembly 56. The assembly 56 can be preferably constructed from several metal components which will be discussed below. As shown in FIGS. 3 and 6, claw assembly 56 includes arms 60 having apertures 58 extending therethrough. Housing 44 of crimping unit 32 is provided with apertures 62 extending through sides 64 thereof (FIG. 4). Claw assembly 56 is positioned within chamber 54 of housing 44 such that apertures 58 of assembly 56 align with apertures 62 and housing 44. A pair of pins 66 (FIG. 3) are provided to extend through apertures 62 and apertures 58 in arms 60 to pivotably link claw assembly 56 within housing 44. In a specific embodiment, pins 66 can be provided with a groove (not shown) at both ends to receive an internal toothed washer which locks pins 66 within apertures 62. Other suitable means may be used to secure pins 66 within housing 44 including an interference fit, welding, or using nuts and bolts.

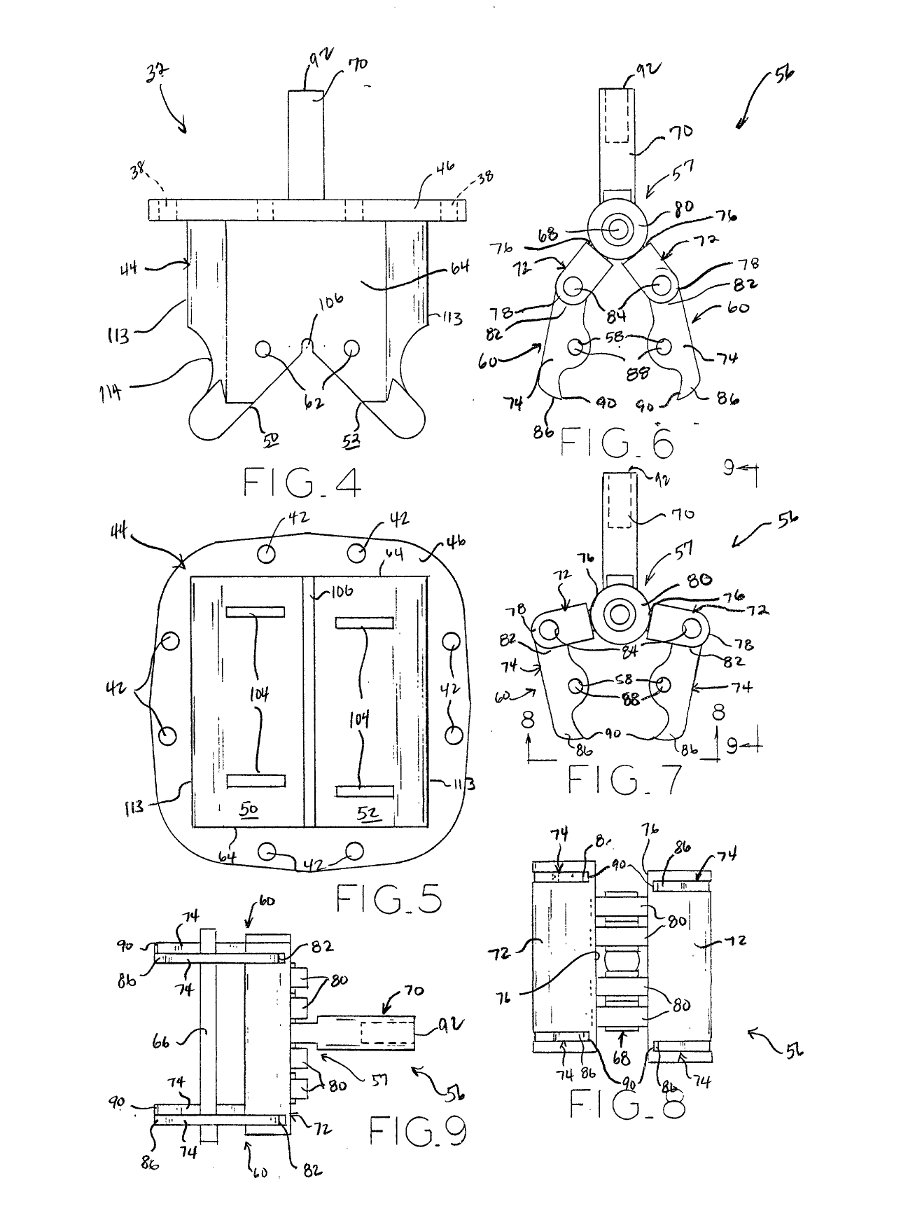

Claw assembly 56 has a first inoperative position as shown in FIG. 6, wherein arms 60 are retracted within chamber 54 of housing 44 (FIG. 10). Claw assembly 56 also has a second, operative position as shown in FIG. 7, wherein one end of arms 60 engages walls 24 and 26 as will be discussed below (FIG. 11). A linkage 57 effects this movement of the claw assembly when receiving a reciprocating input from the tool 30.

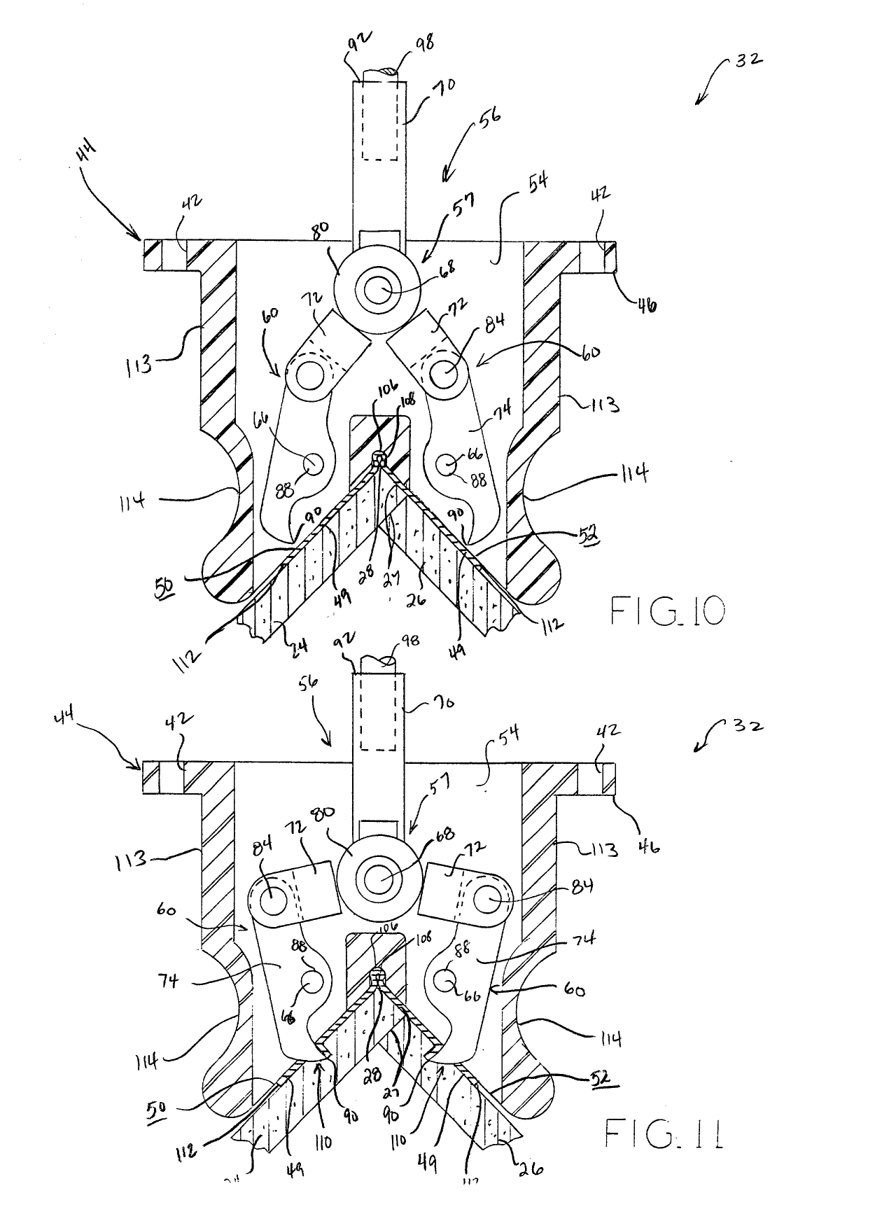

The linkage mechanism 57 includes a central axle 68 about which arms 60 and driving rod 70 are operatively connected. Arms 60 include two links, namely connecting arm 72 and claw arm portion 74. Connecting arm 72 is preferably in the form of an elongated solid beam which extends substantially the width of claw assembly 56 (FIGS. 8 and 9). The first end 76 of each connecting arm 72 is secured to a pair of bearings 80 which are journaled about axle 68 to allow for pivotal movement of connecting arms 72 about axle 68. Connecting arms 72 may be secured to bearings 80 by any suitable means such as being integrally formed with connecting arms 72 or being welded to connecting arms 72.

The second end 78 of each connecting arm 72 is pivotably attached at pivot point 84 to first end 82 of at least one claw arm portion 74. Connecting arm 72 and claw arm portion 74 may be pivotably attached by any suitable means such as a pin or rivet. Any number of claw arm portions 74 may be disposed along connecting arm 72. In this preferred embodiment two such claw arm portions 74 are disposed along each of the two connecting arms 72, which will yield two crimps per housing surface 50, 52. The second end 86 of claw arm portion 74 is free to pivot about pivot point 88 which is defined by pins 66 extending through apertures 58 in the claw arm portion 74 of arms 60.

The second end 86 of each claw arm portion 74 is provided with a sharp, pointed claw edge 90. Each claw edge 90 of claw assembly 56 is configured to pierce the legs 49 of corner bead 22 and the dry wall defining walls 24 and 26. Most preferably, the edges 90 are sharply beveled to pierce sheet metal.

Extending in a direction opposite to that of arms 60 from central axle 68 is a driving rod 70 which has bearing 80 secured to one end thereof. Bearing 80 is journaled about central axle 68 in the same manner as connecting arms 72. End 92 of the driving rod 70 is operatively connected to powered impact tool 30 such that when impact tool 30 is actuated, claw assembly 56 is actuated to pierce corner bead 22 and walls 24 and 26. A conventional impact tool 30, such as a nail gun, is provided with piston 94 which is disposed within chamber 96 in barrel 40 (FIG. 3). Piston 94 travels axially within chamber 96 to advance a nail through the operative end of the tool when used for that purpose. For the present invention, connecting rod 98 is secured to piston 94 and extends through bumper 100 to connect to driving rod 70. Bumper 100 is provided as a buffer to absorb at least a portion of the impact force created by the movement of piston 94. The connection between piston 94 and driving rod 70 allows for actuation of claw assembly 56 when trigger 101 of impact tool 30 is actuated. Alternatively, connecting rod 98 and driving rod 70 may be eliminated, and the driving rod 70 may be directly connected to piston 94.

In the illustrated embodiment, the driving rod 70 is configured to receive a reciprocating input from tool 30. The rod 70 can be connected to other powered sources of reciprocating movement. Alternatively, the axle 68 can be connected to a source of rotary movement.

With the preferred embodiment, when tool 30 is actuated, air is drawn through hose 102 from an air compressor (not shown) into chamber 96 disposed in barrel 40 of impact tool 30. This air forces piston 94 out of chamber 96 in a direction toward crimping unit 32 which forces driving rod 70 outwardly. This movement of driving rod 70 causes rotational movement of connecting arms 72 about central axle 68 such that connecting arms 72 are nearly perpendicularly disposed with respect to driving rod 70 (FIG. 7). With this rotation of connecting arms 72, claw arm portions 74 rotate about pivot points 84 and 88 such that claw edge 90 of claw arm portions 74 rotate toward walls 24 and 26 (FIG. 11). Slots 104 are located within surfaces 50, 52 of housing 44 through which claw edges 90 of claw arm portions 74 pass to simultaneously pierce both legs 49 of corner bead 22 and walls 24 and 26.

In the most preferred embodiment, each pair of slots 104 and thus claw arm portions 74, disposed in respective surfaces 50, 52 are laterally offset from one another (FIGS. 5 and 8). By offsetting claw arm portions 74, the pierced portions of leg 49 of corner bead 22 on wall 24 will be laterally offset from the pierced portions of leg 49 of corner bead 22 on wall 26, thereby adding to the stability of corner bead 22 on walls 24 and 26.

Referring now to FIG. 11, when claw edges 90 engage corner bead 22, edges 90 form notches 110 in wall 24 and 26 which secures corner bead 22 thereto. These notches 110 are formed inwardly from edges 112 of legs 49 of corner bead 22, ensuring that the cut and crimped portion of the leg will pierce walls 24 and 26. Since the claw edge pierces an interior section of each leg of the corner bead 22, the corner bead 22 will be sufficiently attached to walls 24 and 26 to prevent corner bead 22 from pulling away from walls 24 and 26. Since the cut and crimped portion of the corner bead is not at its edges 112, there is little chance for the crimped portions to be dislodged from the underlying dry wall. Moreover, even if legs 49 of corner bead 22 are constructed to a size shorter than a standard corner bead, the placement of the claws allow them to contact the corner bead legs 49. Thus, the present invention will accommodate non-standard sizes of corner beads 22.

With the present invention, when device 20 is actuated, claw edge 90 of claw arm portions 74 pierces a mid-portion of corner bead 22, forcing the cut metal toward corner 28 of walls 24 and 26. A portion of the dry wall behind the cut metal is compacted and corner bead 22 is securely mounted to walls 24 and 26. The corner bead attachment device 20 is simple to align with respect to corner 28 in that notch 106 is provided in housing 44 of crimping unit 32 to receive a protrusion 108 of corner bead 22 (FIG. 10). Further, housing 44 is molded to provide curved gripping portions 114 on side walls 113 which allow the operator a place to grasp the crimping unit 32 while moving device 20 from one position to another along the length of the corner bead. When an operator is using the corner bead attachment device 20, protrusion 108 is placed within notch 106, and trigger 101 of tool 30 is actuated, thereby actuating claw assembly 56 and crimping corner bead 22 into walls 24 and 26. The device 20 is then simply moved along corner 28 as many times as the operator deems necessary, piercing corner bead 22 a plurality of times to adequately secure corner bead 22 to the underlying dry wall sheets.

While the invention has been illustrated and described in detail in the drawings and foregoing description, the same is to be considered as illustrative and not restrictive in character. It should be understood that only the preferred embodiments have been shown and described and that all changes and modifications that come within the spirit of the invention are desired to be protected.

What is claimed is:

1. A device for securing a corner bead to a first and a second wall, said device including a powered impact tool having an operative end, and a crimping unit adapted to be secured to said operative end, said crimping unit comprising a housing, said device comprising:
a claw assembly disposed in said housing, said claw assembly including at least a pair of arms each having a claw edge for piercing the corner bead positioned opposite one another in said housing, said arms having a first, inoperative position and a second operative position, whereby when said impact tool is actuated, said arms move between said first inoperative position and said second operative position, so said claw edges contemporaneously pierce the corner bead and the first and second walls.

2. The device of claim 1, wherein said impact tool is a pneumatic nail gun.

3. The device of claim 1, wherein said claw assembly includes a central axle connected at one end to said operative end of said impact tool and pivotably connected at an opposite end to said pair of arms.

4. The device of claim 1, wherein said housing further includes a plurality of slots through which said second end of said arms pass when actuated.

5. The device of claim 4, wherein one end of said housing further includes a first surface and a second surface, at least one of said slots disposed in each of said first and said second surfaces such that said slots in said first surface are laterally offset relative to said slots in said second surface.

6. The device of claim 1, wherein in said first, inoperative position, said second end of said arms is retracted within said housing.

7. The device of claim 3, wherein said arms further include a connecting arm and a claw portion, wherein said connecting arm has two ends, one of said ends pivotably attached to said central axle and a second of said ends pivotably attached to said claw portion.

8. The device of claim 7, wherein said arm further includes a pivot point between said connecting arm and said claw portion.

9. A device for attaching a corner bead to the corner of a structure having a pair of walls, each of said walls having a free edge positioned adjacent one another, said walls positioned at an angle relative each other, said device comprising:
at least two claw arms each having a first end, a second end and a pivot point therebetween;
at least one claw attached to said first end of each of said claw arms, said claw defining a sharp edge conFIGured for piercing a wall of the corner bead;
a crimping unit supporting said claw arm, said crimping unit having a pair of surfaces oriented relative to each other at the angle of the walls and conFIGured to be pressed flush against the walls of the corner bead, each of said pair of surfaces defining a slot for receiving said claw for movement therethrough, said slot arranged on said corresponding surface to intersect the interior surface of a corresponding wall of the corner bead away from the free edge of the wall,
said crimping unit further including a pivot support for pivotably supporting each of said pair of claw arms at said pivot point, said pivot support arranged relative to said pair of surfaces so that each of said claw arms can pivot to extend said claw through a corresponding slot in said pair of surfaces; and
a mechanism connected to said second end of said claw arms for pivoting said claw arms relative to each other about said pivot support, whereby pivoting said claw arms forces said claw of each of said claw arms to pass through said slot in a corresponding surface of said crimping unit and to pierce the interior portion of each wall of the corner bead inboard of the free edge of the wall, each of said claws forming a notch in the interior portion to secure the corner bead to a corner of the structure.

10. The device of claim 9, wherein said mechanism further comprises:
a driving rod connectable to a power source; and
at least two connecting arms each having a proximal end and a distal end, said distal end pivotably attached to said second end of said claw arm, said proximal end operatively connected to said driving rod.

11. The device of claim 9, wherein said mechanism further comprises a central axle, said driving rod pivotably attached to said central axle and said connecting arms pivotably attached to said central axle.

12. The device of claim 10, wherein said power source is a pneumatic nail gun, said driving rod reciprocates linearly when said nail gun is actuated, effecting rotation of said claws of said claw assembly, whereby contemporaneously pierce the interior portion of each wall of the corner bead inboard of the free edge of the wall.

13. The device of claim 9, wherein said claw has a curved hook-like shape.

14. The device of claim 9, wherein said notch curves inward at an angle of less than 90° relative to the first and second walls.

15. The device of claim 9, wherein said pivot support is an elongated pin, said crimping unit further including a housing, said pin secured at each end in said housing.

16. The device of claim 15, wherein said pivot point of each of said claw arm defines an aperture for rotatably receiving said pin, said pin slidingly insertable into said apertures of said housing, to detachably engage said claw arm to said crimping unit.

17. The device of claim 9, wherein said crimping unit further comprises a pair of lateral side walls, said side walls having a curved gripping portion.

18. The device of claim 9, wherein crimping unit further comprises a chamber for housing said mechanism.

19. The device of claim 18, wherein crimping unit further comprises a receiving end having an opening in communication with said chamber for receiving said mechanism into said chamber, said receiving end having a flange disposed about the perimeter thereof having a plurality of apertures for receiving fasteners.

20. The device of claim 19, wherein said apertures align with apertures in said power source, said fasteners passing through said apertures in said crimping unit and said apertures in said power source, securing said crimping unit to said power source.
